(19) United States
(12) Patent Application Publication
(10) Pub. No.: US 2020/0393903 A1
(43) Pub. Date: Dec. 17, 2020

(54) ACTUATORS FOR PROVIDING MULTIDIRECTIONAL KINESTHETIC EFFECTS

(71) Applicant: Immersion Corporation, San Jose, CA (US)

(72) Inventors: Vahid KHOSHKAVA, Montreal (CA); Robert LACROIX, Saint-Lambert (CA); Colin SWINDELLS, San Jose, CA (US); Sanya ATTARI, Fremont, CA (US)

(21) Appl. No.: 16/437,606

(22) Filed: Jun. 11, 2019

(51) Int. Cl. G06F 3/01

(52) U.S. Cl. CPC G06F 3/016; G06F 3/014

(57) ABSTRACT

Multi-directional kinesthetic actuation systems are provided. The multi-directional kinesthetic actuation systems are configured to provide kinesthetic effects in multiple directions through both pulling and pushing forces. Multi-directional kinesthetic actuation systems include at least an active linkage, one or more hinges, and a motor. The motor is employed to advance or retract the active linkage. The active linkage is activated to provide increased buckling strength to transfer force to the hinges and deactivated to increase flexibility to facilitate retraction by the motor. The hinges are configured to translate the pushing or pulling force provided by the active linkage into a torque to be provided to a user's finger.

### FIELD OF THE INVENTION

The present invention relates to actuators for providing kinesthetic feedback in multiple directions. In particular, embodiments hereof are directed to devices and methods having kinesthetic actuators that provide kinesthetic effects including advancing and retracting movement, vibration, and resistance to advancing and retracting movement.

### BACKGROUND OF THE INVENTION

Kinesthetic effects applied to user interface devices can enhance and enrich the user experience when interacting with such user interface devices. Such effects may be particularly advantageous in a video gaming or immersive reality (virtual reality, augmented reality, mixed/merged reality) setting for providing haptic feedback to a user. Such haptic feedback not only enhances the interaction but may be used to provide valuable information to a user. Due to the value of kinesthetic feedback in various interactive systems, new and efficient ways of providing such feedback are desired.

Conventional feedback devices for providing kinesthetic effects to a user's hands typically include cables or other inactive structures to provide pushing or pulling feedback effects on a user's hands. These types of structures are typically operated in only one direction—tension. To provide effects in both directions of a finger's movement (bending and unbending), multiple cables are needed for each finger, which creates excessive complexity in such devices. In addition, such conventional devices may provide kinesthetic effects with an unnatural feel. Cables or other devices designed to directly pull on a user's finger provide a force that does not correspond appropriately with natural bending and unbending motions, leading to unnatural kinesthetic feelings.

The inventions described herein provide novel and different ways of generating kinesthetic effects via a multi-directional kinesthetic actuation system.

### BRIEF SUMMARY OF THE INVENTION

In an embodiment, a system for applying kinesthetic effects is provided. The system includes a control unit including at least one processor and configured to output an actuator control signal and a motor control signal; an active linkage configured to have an adjustable buckling strength, the buckling strength being adjustable in response to the actuator control signal; a motor configured to advance and retract the linkage in response to the motor control signal; and a hinge configured to convert a translation force supplied by the linkage into torque to apply a kinesthetic effect.

In another embodiment, a method for applying kinesthetic effects is provided. The method includes adjusting, via an actuator control signal output by a processor, a buckling strength of a linkage; causing, via a motor signal output by the processor, a motor to translate the linkage between advanced and retracted positions; providing a translation force to the hinge via the linkage; and converting the translation force supplied into torque at the hinge to apply a kinesthetic effect.

### BRIEF DESCRIPTION OF THE DRAWINGS

The foregoing and other features and advantages of the invention will be apparent from the following description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 illustrates an apparatus for applying kinesthetic effects consistent with embodiments hereof.

FIG. 2 is a schematic illustration of a system for applying kinesthetic effects consistent with embodiments hereof.

FIGS. 3A-3C illustrate operational aspects of an active linkage consistent with embodiments hereof.

FIGS. 4A and 4B illustrate operational aspects of an active linkage consistent with embodiments hereof.

FIGS. 5A and 5B illustrate aspects of a hinge consistent with embodiments hereof.

FIGS. 6A and 6B illustrate an active linkage consistent with embodiments hereof.

FIG. 7 illustrates an active linkage consistent with embodiments hereof.

FIGS. 8A and 8B illustrate an active linkage consistent with embodiments hereof.

FIGS. 9A and 9B illustrate an active linkage consistent with embodiments hereof.

FIG. 10 illustrates a process of generating kinesthetic effects consistent with embodiments hereof.

### DETAILED DESCRIPTION OF THE INVENTION

Specific embodiments of the present invention are now described with reference to the figures. The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Embodiments hereof include kinesthetic actuation systems and devices configured to provide kinesthetic effects. The kinesthetic actuation systems and devices are configured to provide multi-directional kinesthetic effects to a user including causing movement, resisting movement, and vibrations.

More particularly, multi-directional kinesthetic effects provided by systems and devices described herein include pushing and pulling forces provided to a user for bending and unbending of a user's joint(s). Many human movements include rotation of a body part around a joint. For such movements, the application of a direct linear force may fail to provide a meaningful haptic effect to the user. For example, pushing a fingertip linearly away from a wrist of a user does not correspond to any common forces or stimulations that the user may experience. To address this issue, systems and devices provided herein convert pushing and pulling forces into torques to provide or resist bending and unbending movements of a user's body part around a respective joint.

Pushing and pulling forces generated by kinesthetic actuation systems as described herein may be employed to generate torque to cause rotational movement of a user's body part. Rotational movement of a user's body part may be employed to provide a user with kinesthetic effects consistent with rapid action, such as a car crash or a gun shot, or with slower actions. Pushing and pulling forces may be employed to generate torque to resist movement of a user's body part. For example, such forces may be employed to simulate the difficulty of squeezing an object. Vibration effects may be employed to provide a user with kinesthetic effects representative of in-game actions, such as rapid shaking or driving a car across rough terrain. Effects provided by systems and devices described herein may be employed to provide a direct simulation of immersive reality events (e.g., squeezing an object) and/or to provide kinesthetic cues associated with immersive reality events (e.g., a vibration when contact is made with an object or when a selection is made on a menu). The foregoing are merely examples of situations where appropriate kinesthetic effects may be provided and are not intended to limit potential uses of the kinesthetic actuation devices and systems described herein.

In embodiments, multi-directional kinesthetic effects include forces generating torques configured to act against a user's finger to open and close the finger. Apparatuses and systems described herein are discussed with respect to action on a single finger. Such apparatuses and systems may be modified, however, to operate on multiple fingers at once and/or may be incorporated into systems having multiple actuation apparatuses to independently operate on multiple fingers. Apparatuses described herein may further be adapted to provide similar multi-directional effects to other body parts of a user. Such pushing and pulling forces may be provided to generate torque to cause movement of a user's body part or to resist movement of a user's body part, in multiple directions.

In an example, a user may interact with a job simulator virtual reality environment while wearing a handheld peripheral that includes two multi-directional kinesthetic actuation systems consistent with embodiments hereof. One multi-directional kinesthetic actuation system provides kinesthetic effects to the user's index finger while the other provides kinesthetic effects to the user's thumb. As the user grasps and explores virtual objects in the simulation, they receive kinesthetic effect feedback simulating the objects that are handled. For example, in an oil change scenario in an auto mechanic game of the simulator, the user receives kinesthetic effects when contacting and gripping an oil cap while unscrewing it to change the oil. Such effects may provide the user with sensory information to make the simulation more realistic.

In another example, a user operating a peripheral that includes one or more multi-directional kinesthetic actuation systems consistent with embodiments hereof may be provided with different levels of kinesthetic effects to simulate properties of an object that they are looking to purchase. For example, the kinesthetic effects may simulate the firmness of various sofa cushions.

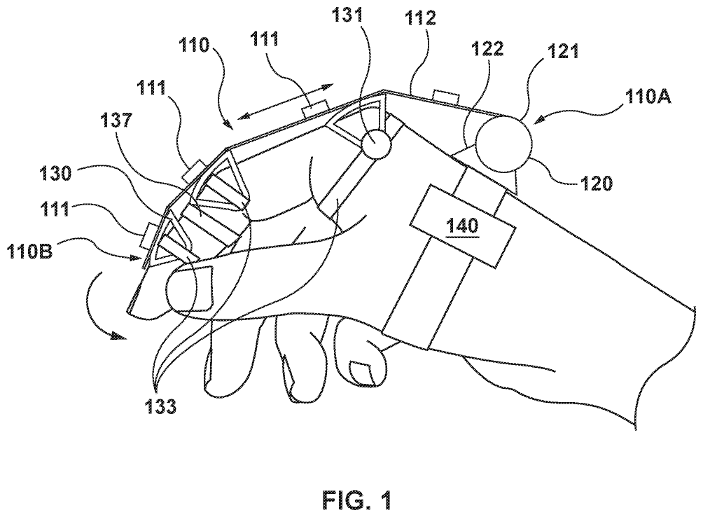

FIG. 1 illustrates a system for applying kinesthetic effects consistent with embodiments hereof. A kinesthetic actuation system 100 of FIG. 1 includes an active linkage 110, a motor 120, one or more hinges 130, and a control unit 140.

As used herein, the term “active linkage” refers to a mechanical linking component having modifiable structural properties. In an embodiment, the active linkage 110 may be configured to have an adjustable buckling strength. The active linkage 110 is configured to receive an actuator control signal from the control unit 140 that adjusts the buckling strength of the active linkage 110. The active linkage 110 is a linkage that transfers force generated by the motor 120 as a linear translational force to the hinges 130. The active linkage 110 pushes and pulls on the hinges 130 when advanced and retracted by the motor 120. The active linkage 110 is configured to have an adjustable buckling strength to permit it to operate in tension and compression. The buckling strength may be increased in a compression operational mode and decreased in a tensile operational mode to provide increased flexibility.

The active linkage 110 includes a ribbon structure 112 with one or more actuators 111 located thereon. The active linkage 110 is configured to transition from an inactive state to an active state having an increased buckling strength in response to the actuator control signal. The actuator control signal is provided to activate the actuators 111 to alter the shape of the ribbon structure 112 so as to increase the buckling strength of the active linkage 110. In other words, the increase in buckling strength of the active linkage 110 is due to activation of actuators 111 disposed thereon. Characteristics of the actuator control signal, including signal amplitude, frequency, and duration, are adjusted by the control unit 140 to modify the amount of increased buckling strength.

The active linkage 110 is attached at a proximal end 110A to a motor 120 and extends from the motor 120 to one or more hinges 130. The ribbon structure 112 of the active linkage 110 is coupled to each hinge 130, as described further below, and extends to a distal end 110B that is attached to the hinge 130 that is farthest away from the motor 120. The actuator(s) 111 is/are configured to induce a curvature in the ribbon structure 112 of the active linkage 110 when activated by an actuator control signal. Curvature in the ribbon structure 112 of the active linkage 110 increases the buckling strength of the active linkage 110, which enables the active linkage 110 to provide a pushing translation force on the hinges 130 without buckling. The actuator(s) 111 may include, for example, MFC (macrofiber composite) actuators, piezo electric actuators, electro active polymers, and/or any other suitable actuator for inducing a curvature in the active linkage 110.

Modeling analysis of ribbon structures 112 consistent with embodiments hereof shows that induced curvature in a ribbon structure 112 can increase the stiffness of structure by as much as nine times. In a simulation involving a rectangular plate, measuring 30 mm×19 mm×0.5 mm, induced curvature increased the stiffness of the plate structure by nine times relative to the same plate with no induced curvature. As discussed below, buckling strength is directly related to stiffness, and increases to stiffness result in increases in buckling strength.

The motor 120 is configured to advance or retract the active linkage 110. Advancing the active linkage 110 causes the active linkage 110 to provide a pushing force to the hinges 130 and retracting the active linkage 110 causes the active linkage 110 to provide a pulling force to the hinges 130. The motor 120 is an AC or DC motor that provides torque to rotate a spool 121. The spool 121 is coupled to the active linkage 110 and causes the advancement or retraction of the active linkage 110 when it is spun by the motor 120. The motor 120 causes retraction of the active linkage 110 by spinning/rotating the spool 121 such that the active linkage 110 is wound around the spool 121, or reeled in. The motor 120 causes the advancement of the active linkage 110 by spinning/rotating the spool 121 in an opposite direction such that the active linkage 110 is unwound from the spool 121, or reeled out. The motor 120 and the spool 121 are coupled to a mounting device 122 that is configured to secure the motor 120 and the spool 121 to a body portion of the user. In the embodiment shown in FIG. 1, the mounting device 122 is configured to secure the motor 120 and the spool 121 to a wrist of a user or a back of a user's hand. The mounting device 122 may include, for example, an adjustable strap for wrapping around a user's hand. In additional embodiments, the mounting device 122 may be configured for mounting to the user in any suitable fashion, including adhesives, clothing clips, etc. In further embodiments, the motor may be a linear drive motor or any other type of motor capable of advancing and retracting the active linkage 110.

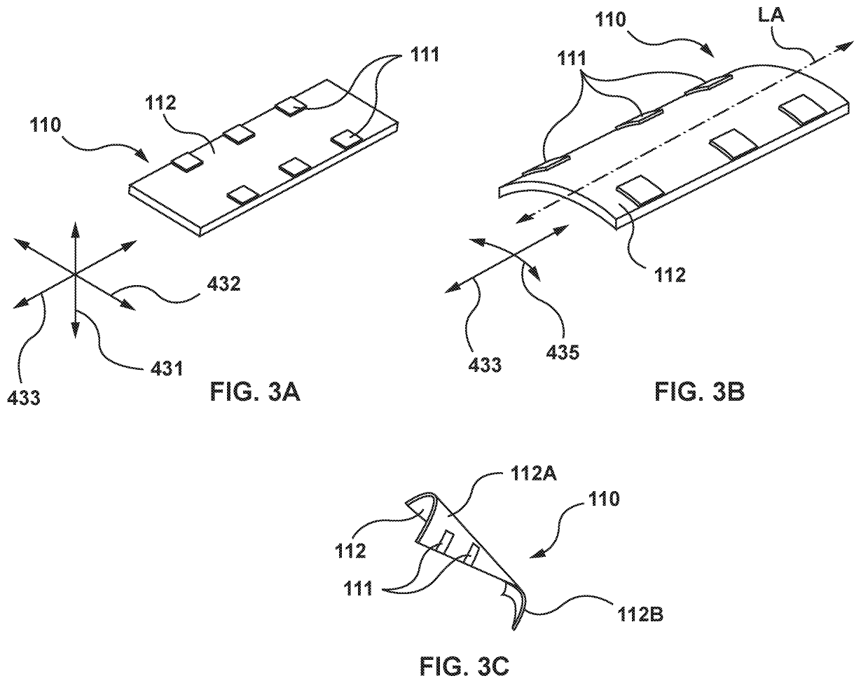

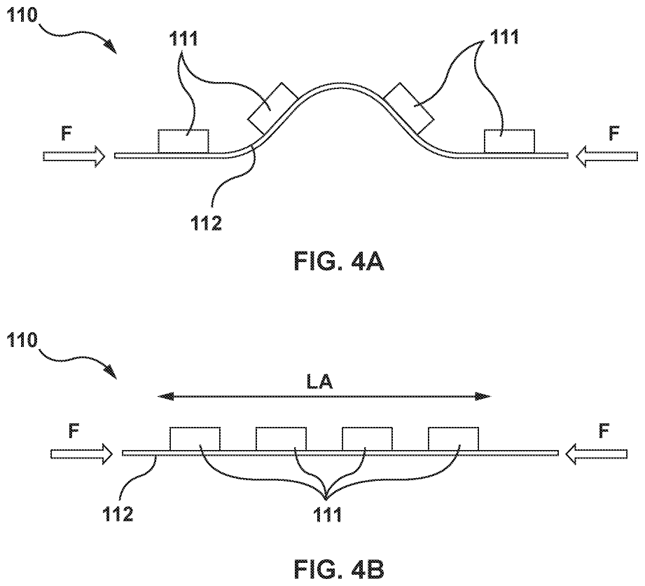

Referring now to FIGS. 3A-4B, the active linkage 110 is described in greater detail.

FIGS. 3A-3C show a perspective view of a portion of the active linkage 110 consistent with embodiments hereof. FIGS. 3A-3C illustrate only a portion of the active linkage 110. FIG. 3A illustrates the active linkage 110 in an inactive state, when no curvature is induced. The active linkage 110 includes the ribbon structure 112 having a rectangular cross-section. The ribbon structure 112 may be made from any suitable metal, plastic, composite, or other material. The ribbon structure 112 of the active linkage 110 has a length dimension 433 substantially larger than its width dimension 432 and has a width dimension 432 substantially larger than a height dimension 431. As a non-limiting example only, a length dimension 433 substantially larger than a width dimension 432 may mean that the active linkage 110 is at least five times, at least ten times, at least thirty times, at least fifty times, at least seventy-five times, or at least one hundred times as long as wide. As an example only, a width dimension 432 substantially larger than a height dimension 431 may mean that the active linkage 110 is at least five times, at least ten times, at least thirty times, at least fifty times, at least seventy-five times, or at least one hundred times as long as wide.

FIG. 3B illustrates the active linkage 110 in an active state. When activated in response to an actuator control signal, the actuators 111 induce and/or adjust a curvature in the width dimension 432 of the active linkage 110 about a longitudinal axis LA of the linkage such that the arc 435 of the induced curvature is perpendicular to the longitudinal axis LA of the active linkage 110, as shown in FIG. 3B. Modifying the curvature of the active linkage 110 about the longitudinal axis LA modifies the area moment of inertia or second moment of inertia of the ribbon structure 112. The buckling strength of a structure such as the ribbon structure 112 is determined by Euler's column formula and depends on the area moment of inertia and the material stiffness (Young's modulus). Increases in the area moment of inertia result in increases in buckling strength. Generally, the area moment of inertia of a structure is larger where more of the beam's cross-sectional area is located away from the centerline of the beam. Although equations for the area moment of inertia differ depending on the cross-sectional shape of the beam, total values of the area moment of inertia generally scale according to the fourth power of the height of the beam cross section. In a curved state, the area moment of inertia of the ribbon structure 112 is relatively larger than in a flat state, as portions of the cross-sectional area extend further away from the centerline of the curved ribbon structure 112, thereby increasing the effective height of the ribbon structure 112. Thus, in a curved state, as depicted in FIG. 3B, the ribbon structure 112 has an increased buckling strength.

FIG. 3C illustrates the active linkage 110 in a partially active state. In embodiments, the active linkage 110 may be partially activated to facilitate reeling in and out of the motor spool 121 (see FIG. 1). The actuators 111 on a distal portion 112A of the ribbon structure 112 that extends away from the spool 121 are activated to increase the buckling strength of the distal portion 112A, while the active linkage 110 at a proximal portion 112B of the ribbon structure 112 that remains wound around the motor spool 121 is inactive to permit the proximal portion 112B of the ribbon structure 112 to easily wrap around the motor spool 121. As the motor 120 (see FIG. 1) advances or retracts the active linkage 110 according to the motor control signal, the actuator control signal selectively activates actuators 111 to modify the buckling strength of specific portions of the ribbon structure 112.

Activation of the actuators 111 induces a curvature about the longitudinal axis LA of the ribbon structure 112. The actuators 111 may be macrofiber composite (MFC) actuators, smart material actuators, such as electroactive polymer actuators, and/or shape memory material actuators configured to force the ribbon structure 112 to bend when activated. The actuators 111 are configured for contraction, expansion, or both, depending on an actuator control signal received. The expansion or contraction of the actuators 111 provides a bending force on the ribbon structure 112 to which the actuators 111 are attached. The bending force causes a change in curvature of the ribbon structure 112. Changes in the curvature of the ribbon structure 112 provide an increased buckling strength to the active linkage 110, as discussed above.

FIGS. 3A-3C illustrate an embodiment of an active linkage that includes a ribbon structure that, when activated, exhibits an increase in buckling strength. Further embodiments include active linkages with different characteristics. For example, a ribbon structure based active linkage may be configured such that it is curved in an inactive state and the activation of actuators thereon reduces the curvature of the ribbon structure, thereby decreasing the buckling strength. The actuator control signal may be provided to decrease the buckling strength by an amount that depends on characteristics of the actuator control signal. In still further embodiments, an active linkage consistent with embodiments hereof may be configured to transition from an inactive state to an active state having either increased or decreased buckling strength depending on the actuator control signal provided. For example, a ribbon structure consistent with this embodiment may have a natural state that is partially curved. Activation of actuators thereon may cause the ribbon structure to flatten to decrease the buckling strength or may cause the ribbon structure to increase in curvature to increase the buckling strength. Thus, the control unit may provide a first actuator control signal to increase the buckling strength of the active linkage during motor advancement and a second actuator control signal to decrease the buckling strength of the active linkage during motor retraction. In either case, the amount of increase or decrease of the buckling strength depends on characteristics of the actuator control signal.

In further embodiments, the active linkage may include a bi-stable ribbon structure configured to have two stable mechanical shapes. The first stable shape is flat and the second stable shape is curved. The actuators located on the bi-stable ribbon structure may be employed to snap the bi-stable ribbon structure between the two stable shapes to increase the buckling strength (in the curved shape) or decrease the buckling strength (in the flat shape). A bi-stable shape may permit the active linkage to transition between increased and decreased buckling strength configurations with less energy expenditure.

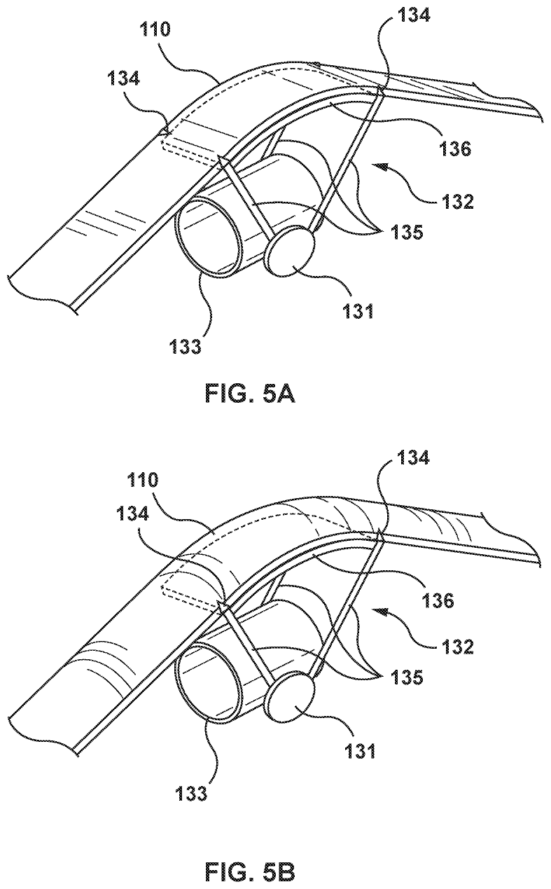

In additional embodiments, active linkages may include different components and/or different structures. Additional embodiments of active linkages are illustrated in FIGS. 5-7.

FIGS. 4A and 4B illustrate operational principles of the active linkage 110 consistent with embodiments hereof. FIG. 4A illustrates the active linkage 110 in an inactive state when subject to compressive forces and FIG. 4B illustrates the active linkage 110 in an active state when subject to compressive forces. In the inactive state, the active linkage 110 has little resistance to buckling. When subject to compressive force, the active linkage 110 buckles and cannot carry/transfer force. In the inactive state, the active linkage 110 can only transfer force to the hinges 130 in a tension mode when it is retracted by the motor 120. In an active state, as depicted in FIG. 4B, the actuators 111 of the active linkage 110 are activated to increase the buckling strength of the active linkage 110 through an increase in the curvature of the ribbon structure 112 about the longitudinal axis LA. In the active state, the active linkage 110 has increased resistance to buckling such that, when subject to compressive forces, the active linkage 110 does not buckle. Accordingly, when used in the kinesthetic actuation system 100, the activated active linkage 110 can provide force to the hinges 130 when it is advanced by the motor 120.

With reference now to FIG. 1 and FIGS. 5A and 5B, the hinges 130 are described in greater detail. The hinges 130 are configured to convert the translation force supplied by the active linkage 110 into a torque to apply the kinesthetic effect. Each hinge 130 includes one or more rotation elements 131 (see FIGS. 5A and 5B), a frame 132 (see FIGS. 5A and 5B), a hinge securement 137, a wearable element 133, and a pair of ribbon guides 134 (see FIGS. 5A and 5B). The ribbon guides 134 are configured to secure the active linkage 110 to the frame 132. The frame 132 is configured to receive the translation (i.e., pushing or pulling) force supplied by the active linkage 110 and to rotate around the rotation element 131. Thus, the force provided to the frame 132 results in a torque around the rotation element 131. The hinge securement 137 is configured to secure the frame 132 of the hinge 130 to the phalange of a user's finger.

FIGS. 5A and 5B illustrate the hinges 130 and their component parts. FIG. 5A illustrates a hinge 130 and an unactivated active linkage 110, while FIG. 5B illustrates the hinge 130 and an activated active linkage 110. Each hinge 130 is secured to the user by the wearable element 133 at the location of the rotation element 131 at an interphalangeal joint of a finger. Each hinge 130 is secured to the user such that the frame 132 of the hinge 130 is rotatable around the rotation elements 131. The hinge 130 is secured to the user, for example, by the wearable element 133, such as a ring or strap. The rotation elements 131 are secured to the wearable element 133 and are configured to permit rotation of the hinge 130 with respect to the wearable element 133. The rotation element 131 may include, for example, bearings, a ball and socket, a living hinge, and/or any other type of joint that permits rotation. The frame 132 of the hinge 130 is also secured to the user by the hinge securement 137 to provide torque on the finger phalanges to cause bending and unbending movement of the finger as well as resistance to bending or unbending movement of the finger. The hinge securement 137 may include straps, tethers, and/or any suitable structure.

The frame 132 includes a plurality of struts 135 and a bridge portion 136. The rotation elements 131 are attached to the wearable element 133 and are located on either side of the finger to which the hinge 130 is secured. The struts 135 extend from the rotation elements 131 on each side to the bridge portion 136, which spans between the struts 135. Each side of the frame 132 may include one or more struts 135. For example, each side of the frame 132 may include two struts 135 extending at an acute angle from one another. The bridge portion 136 extending between the struts 135 may be curved so as to form a pie slice shape in when viewed from the side. The bridge portion 136 is curved to provide a curved pathway for the ribbon structure to follow the natural curvature of the finger.

The active linkage 110 is coupled to the frame 132 of each hinge 130 by the ribbon guides 134 disposed at the ends of the struts 135. The ribbon guides 134 secure the ribbon structure 112 of the active linkage 110 to the frame 132 and further act to guide the ribbon structure 112 over the curve of the bridge portion 136. In this way, the ribbon guides 134 serve to maintain a curvature of the ribbon structure 112 that is consistent with the curvature of a user's finger. The ribbon guides may secure the active linkage 110 by clamping it to the bridge portion 136 or through any other means of coupling, including welding, riveting, adhesives, fasteners, etc.

For the kinesthetic actuation system 100, configured to cause kinesthetic effects that move or resist movement (i.e., bending and unbending) of a finger, it is necessary to translate the linear translation force provided by the active linkage 110 into a torque. The movement of a finger is primarily based on rotation of the phalanges at the interphalangeal joints between each phalanx (i.e., at the knuckles). Because finger movement is based on the rotation of the phalanges, applying translational forces to a finger cannot provide a wide array of kinesthetic effects. A device that provides a linkage between a tip of the finger and a motor at the back of the hand can only provide linear force that is approximately perpendicular to the arc of rotation of the tip of the finger. Such a linear force cannot efficiently exert force in the direction of movement of tip of the finger, and therefore can provide only limited kinesthetic effects. In contrast, the rotation of the hinge 130 converts the linear motion of the active linkage 110 into rotational motion of the hinge 130, and thus converts the linear force into torque that is applied to a finger of the user.

When the active linkage 110 is advanced, the force of the active linkage 110 is transferred to the hinges 130 through the connection at the ribbon guides 134 and each of the hinges 130 rotates forward (away from the wrist) to provide torque by pushing on the phalange directly in front of it through contact between the bridge portion 136 and the finger. When the active linkage 110 is advanced, the torque is provided to cause a bending movement of the finger or resist an unbending movement of the finger. When the active linkage 110 is retracted, each of the hinges 130 rotates backward (towards the wrist) and provides torque by pulling on the phalange directly in front of it via the hinge securement 137. When the active linkage 110 is retracted, the torque is provided to cause an unbending movement of the finger or to resist a bending movement of the finger.

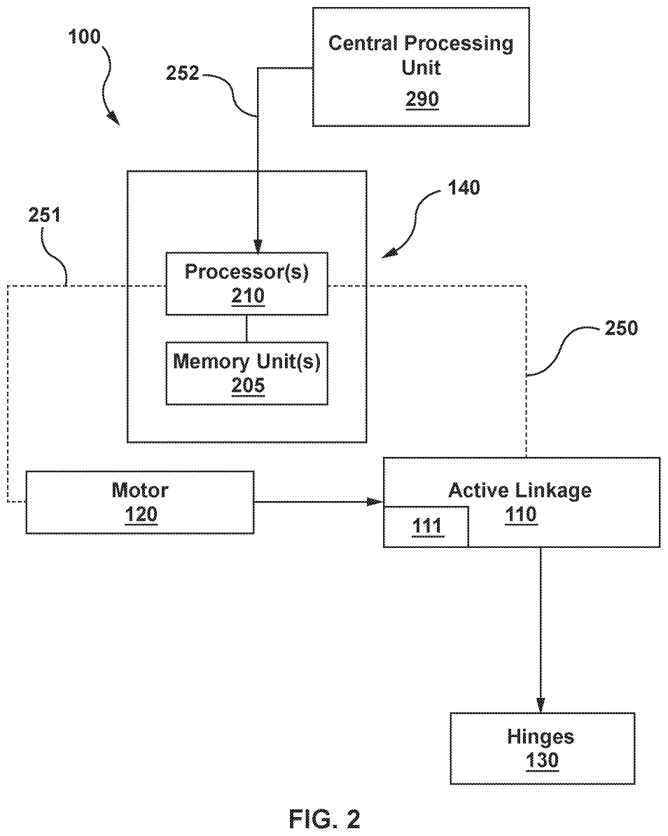

Operation of the kinesthetic actuation system 100 is now described with reference to FIGS. 1 and 2. FIG. 2 is a schematic illustration of components of the kinesthetic actuation system 100 consistent with embodiments hereof. As described above, the kinesthetic actuation system 100 includes at least one controller 140, at least one active linkage 110, at least one hinge 130, and at least one motor 120. The controller 140 includes at least one processor 210 and at least one memory unit 205.

The processor(s) 210 are programmed by one or more computer program instruction stored in the memory unit(s) 205. The functionality of the processor(s) 210, as described herein, is implemented by software stored in the memory unit(s) 205 or another non-transitory computer-readable or tangible medium and executed by the processor 210. As used herein, for convenience, the various instructions may be described as performing an operation, when, in fact, the various instructions program the processors 210 to perform the operation. In other embodiments, the functionality of the processor may be performed by hardware (e.g., through the use of an application specific integrated circuit (“ASIC”), a programmable gate array (“PGA”), a field programmable gate array (“FPGA”), etc.), or any combination of hardware and software.

The various instructions described herein may be stored in the memory unit(s) 205, which may comprise a non-transitory computer readable medium such as random access memory (RAM), read only memory (ROM), flash memory, and/or any other memory suitable for storing software instructions. The memory unit(s) 205 store the computer program instructions (e.g., the aforementioned instructions) to be executed by the processor 210 as well as data that may be manipulated by the processor 210.

The processor 210 is configured to transmit or send an actuator control signal 250 to the actuators 111 of the active linkage 110. The actuator control signal 250 is configured to cause an increase in the buckling strength of the ribbon structure 112 of the active linkage 110 via activation of one or more actuators 111 associated with the active linkage 110. An amount of buckling strength increase may depend on characteristics of the actuator control signal, such as amplitude, frequency, and/or duration. The processor 210 is configured to stop sending the actuator control signal 250 to deactivate the active linkage 110 and return the buckling strength of the active linkage 110 to normal.

In further embodiments, the processor 210 may be configured to send actuator control signals 250 to modify the buckling strength of any active linkage described herein. As described herein, the various active linkages may require different actuator control signals to enter active and inactive states and to increase or decrease their buckling strength. The processor 210 and the control unit 140 may be configured to be operable with any active linkage described herein.

The processor 210 is configured to transmit or send a motor control signal 251 to the motor 120. The motor control signal 251 is configured to cause the motor 120 to advance or retract the active linkage 110. The advancing or retracting active linkage 110 provides forces on the hinge(s) 130 that are then transferred to the finger of the user, as described above.

The actuator control signal 250 and motor control signal 251 are generated by the processor 210 according to parameters of a software application with which a user of the kinesthetic actuation system 100 is interacting. The kinesthetic actuation system 100 is configured to provide kinesthetic effects, e.g., movement inducing forces, forces resisting movement, and/or vibration. The kinesthetic effects are provided to enhance the experience of a user employing the kinesthetic actuation system 100 to interact with a software application, such as a game or productivity application. The processor 210 interacts with one or more central processing units 290 of a computer system running software applications with which a user is interacting. For example, a user may be interacting with an immersive reality software application. Interactions by the user that occur within the immersive reality setting may cause the central processing unit(s) 290 to generate kinesthetic effects intended for output to the user. Such effects may include pushing, pulling, resistance, and/or vibration forces on the user finger. The central processing unit(s) 290 provide the processor 210 with a command signal 252 including instructions to produce the generated kinesthetic effects. The processor 210 generates the actuator control signal 250 and the motor control signal 251 based on the received command signal 252. In embodiments, the command signal 252 may include high-level instructions to implement a specific kinesthetic effect and the processor 210 may generate the actuator control signal 250 and the motor control signal 251 required to perform that kinesthetic effect. In further embodiments, the command signal 252 may include specific actuator control commands and motor control commands and the processor 210 may interpret these and generate the actuator control signal 250 and the motor control signal 251 according to the specific commands.

In embodiments, the control unit 140 of the kinesthetic actuation system 100 is collocated with other components of the kinesthetic actuation system 100, e.g., attached to the motor 120, mounting device 122, or other wearable portion of the kinesthetic actuation system 100. In embodiments, the processor 210 is located remotely from the kinesthetic actuation system 100 and supplies the actuator control signals 250 and the motor control signals 251 to the kinesthetic actuation system 100 wirelessly or via wires. In embodiments, the kinesthetic actuation system 100 does not include the controller 140, and the requisite actuator control signals 250 and the motor control signals 251 are supplied by an external processing unit, such as the central processing unit 290. The processor 210 or another processor of similar capabilities may be associated with or part of another system which provides the actuator control signals and the motor control signals to the kinesthetic actuation system 100.

The control unit 140 includes the processor 210 configured to output actuator control signals 250 and motor control signals 251. The actuator control signal 250 is configured to activate the active linkage 110 to cause an increase in buckling strength. The actuator control signal 250 may be stopped to deactivate the active linkage 110 to cause a decrease in buckling strength. The motor control signal 251 is configured to activate the motor to advance or retract the active linkage 110.

The combination of actuator control signals 250 and motor control signals 251 used is selected according to the characteristics of the motor and active linkage used in the kinesthetic actuation system 100, as follows. For example, the control unit 140 provides actuator control signals 250 and motor control signals 251 to aspects of the kinesthetic actuation system 100, employing a motor 120 for providing rotational motion and an active linkage 110 having a ribbon structure 112 with actuators 111 located thereon for inducing curvature and increasing buckling strength. To cause a compression based, or pushing, force on the hinges to create a kinesthetic effect for providing a bending movement to the finger, the control unit 140 is configured to send an actuator control signal 250 to the actuators 111 of the active linkage 110 to increase the buckling strength of the ribbon structure 112 of the active linkage 110 when the active linkage 110 is to be advanced. The control unit 140 is also configured to send a motor control signal 251 to cause the motor 120 to rotate the spool 121 to advance the active linkage 110. The active linkage 110 advances and applies forces to the hinges 130. The linear force provided to the hinges 130 creates a torque around the rotation elements 131 of the hinges causing the hinges 130 to rotate forward, e.g., away from the wrist of the user. The bridge portion 136 of the frames 132 of the rotated hinges 130 contacts the phalanges of the user's finger to provide a force pushing the finger closed.

To cause a kinesthetic effect to resist an unbending movement of the finger, the control unit 140 sends an actuator control signal 250 to activate the active linkage 110 to increase the buckling strength and a motor control signal 251 configured to cause the motor 120 to hold the spool 121 in place against an external force (i.e., the force provided by the user attempting to unbend their finger.) The force of the motor is transferred through the active linkage 110 to the hinges 130 to create a torque around the rotation elements 131. As the user attempts to unbend their finger, the phalanges of the finger contact the bridge portions 136 frames 132. The force of the user unbending their finger is resisted by the torque created by the active linkage 110.

To cause a kinesthetic effect that provides an unbending movement to the finger, the control unit 140 is configured to send no actuator control signal 250, allowing the active linkage 110 to return to or remain in its inactive state. The control unit 140 also sends a motor control signal 251 to cause the motor 120 to rotate the spool 121 to retract the active linkage 110. The motor 120 creates a tension force in the active linkage 110, which is transferred to the hinges 130 to provide a torque around the rotation elements 131. This torque acts to rotate the hinges towards the wrist of the user. The hinge frames 132, which are secured to the phalanges of the finger via the hinge securement 137, pull on the finger phalanges with a torque that tends to unbend the finger.

To cause a kinesthetic effect that resists a bending movement of the finger, the control unit 140 sends no actuator control signal 250 to allow the active linkage 110 to relax to its natural state. The control unit 140 also sends a motor control signal 251 configured to cause the motor 120 to hold the spool 121 in place against an external force (i.e., the force provided by the user attempting to bend their finger.) The motor 120 creates a tension force in the active linkage 110, which is transferred to the hinges 130 to provide a torque around the rotation elements 131. The hinge frames 132, which are secured to the phalanges of the finger via the hinge securement 137, pull on the finger phalanges with a torque that acts to resist the torque created by the user as the user attempts to close their finger.

In further embodiments, an actuator control signal 250 may still activate the active linkage 110 to increase buckling strength even when such additional buckling strength is unnecessary (e.g., the active linkage 110 is operating in tension).

In still further embodiments, the control unit 140 may be configured to send an actuator control signal 250 selectively activate actuators of the active linkage 110 such that some portions of the active linkage 110 have increased buckling strength and some portions of the active linkage 110 do not have increased buckling strength.

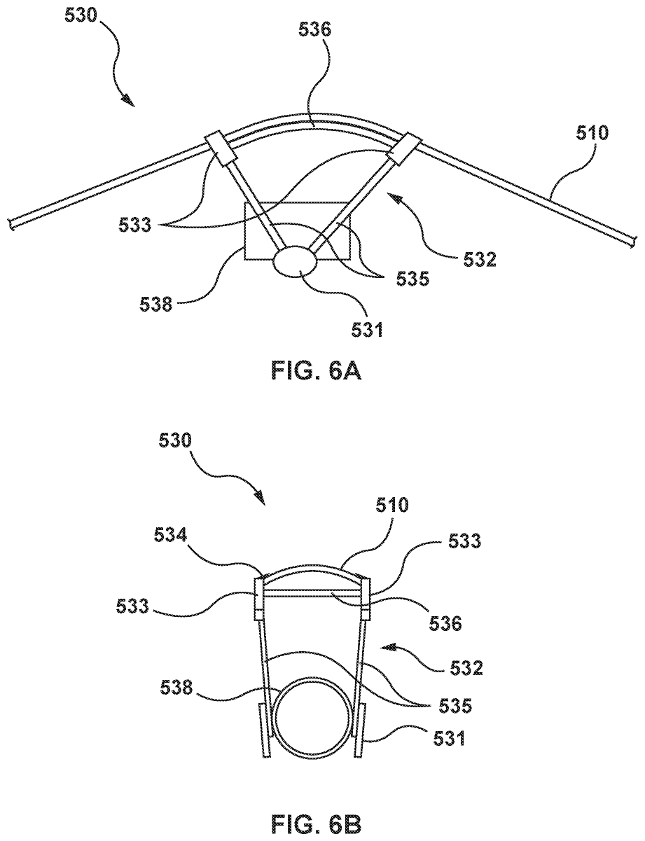

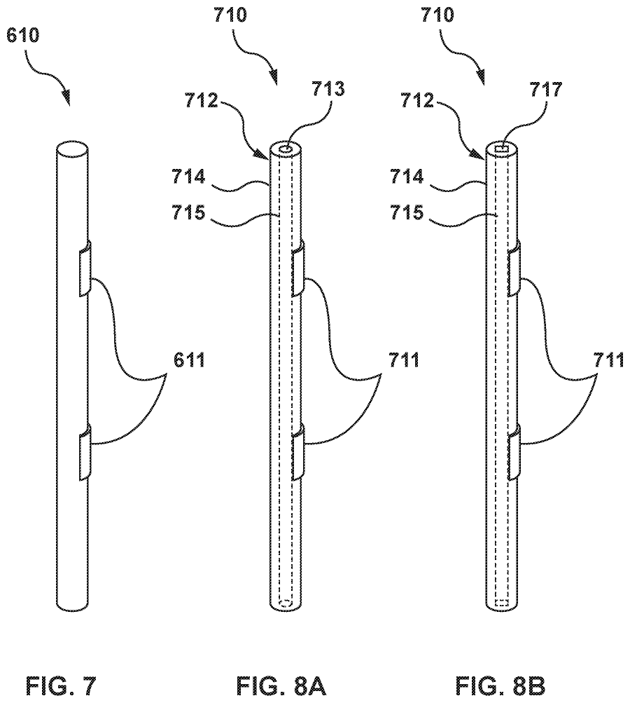

In still further embodiments, as discussed below with respect to FIGS. 6A, 6B and 7, an active linkage consistent with the kinesthetic activation system 100 may have an increased buckling strength in an inactive state and a decreased buckling strength in an active state. The control unit 140 may be configured so as to provide the appropriate actuator control signals 250 for the alternate active linkages. For example, the actuator control signal 250 may be supplied to an active linkage to decrease the buckling strength for provision of tension based kinesthetic effects. For providing compression based haptic effects, the actuator control signal 250 may be absent to allow the active linkage to return to an inactive state having an increased buckling strength as compared to an activated state of the active linkage.

In further embodiments, the controller 140 may operate to cause vibration kinesthetic effects. In embodiments, the controller 140 may provide oscillating motor control signals 251 and actuator control signals 250 to alternately provide pushing and pulling forces to the user's finger through the active linkage 110 and the hinges 130. In embodiments, the controller 140 may provide oscillating motor control signals 251 and/or actuator control signals 250 to alternate between pushing forces and reduced or absent forces. In embodiments, the controller 140 may provide oscillating motor control signals 251 and/or actuator control signals 250 to alternate between a pulling force and a reduced force or no force.

FIGS. 6A and 6B illustrate an active linkage 510 consistent with embodiments discussed herein. FIG. 6A illustrates a side view of the hinge 530 with the active linkage 510 in an inactive state. The active linkage 510 is a ribbon structure similar to the active linkage 110 and is configured with a length substantially larger than a width and a width substantially larger than a height. The active linkage 510 includes no actuators. The active linkage 510 may be employed with one or more hinges 530. The hinge 530 includes a rotation element 531, a frame 532, at least one ribbon guide 534, a wearable element 538, and at least one actuator 533. The hinge 530 operates similarly to the hinge 130 to translate forces applied by the active linkage 510 into forces and/or torques applied to a finger of the user. Similar to the hinge 130, the frame 532 of the hinge 530 includes a curved bridge portion 536 and a plurality of struts 535 connecting the rotation element 531 to the bridge portion 536. The frame 532 further includes the one or more ribbon guides 534 configured to couple the active linkage 510 to the hinge 530.

FIG. 6B illustrates an end-on view of the hinge 530 with the active linkage 510 in an activated state having an increased buckling strength. The actuator(s) 533 of each hinge 530 are activated to induce curvature in the active linkage 510 to increase the buckling strength of the active linkage 510. The actuator(s) 533 are configured to apply a force to the active linkage 510 that induces a curvature in the ribbon structure to increase the buckling strength of the ribbon structure when an actuator control signal is received by the actuator 533. In embodiments, the active linkage 510 may be a bi-stable ribbon structure configured to have two stable mechanical shapes. The first stable shape is a flat shape and the second stable shape is a curved shape. The actuators 533 are employed to snap the bi-stable ribbon structure between the two stable shapes to increase the buckling strength (in the curved shape) or decrease the buckling strength (in the flat shape). A bi-stable shape may permit the active linkage 510 to transition between an increased and decrease buckling strength configurations with less energy expenditure. The active linkage 510 and hinge 530 may be employed with the kinesthetic actuation system 100 as described in detail with respect to FIGS. 1 and 2. In further embodiments, the hinge actuators 533 may be employed with the active linkage 110 to provide multiple means of inducing curvature within the same kinesthetic actuation system.

FIG. 7 illustrates an active linkage 610. The active linkage 610 has a circular cross-section and a length substantially greater than its diameter. The active linkage 610 includes a shape memory material. The active linkage 610 may be activated through temperature changes to adjust its buckling strength. The active linkage 160 may be selected to have a glass transition temperature (T_{g}) close to a room temperature, e.g., between 25-60° C. Appropriate materials may include, for example, poly-caprolactone, poly-cyclooctene, pCO-CPE blend, PCL-BA copolymer, Poly(ODVE)-co-BA, copolyester, PMMA-PBMA copolymers, epoxy, fish oil copolymers, PET-PEG copolymer, thermosetting PU, PET-PEG copolymer, P(MA-co-MMA)-PEG, soybean oil copolymers, polynorbornene, POSS telechelic, PLAGC multiblock copolymer, Aramid/PCL, PVDF/PVAc blends, and others. Increasing the temperature of the active linkage 610 beyond a glass transition temperature (T_{g}) of the shape memory material causes an increase in flexibility and a reduction in buckling strength of the active linkage 610. Similarly, reducing the temperature of the active linkage 610 below the glass transition temperature of the shape memory material causes an increase in stiffness and a corresponding increase in buckling strength of the active linkage 610. The temperature of the active linkage 610 may be adjusted via temperature control actuators 611 disposed on the active linkage 610, disposed on the hinges of a kinesthetic actuation system, and/or disposed in any other location from which they may heat or cool the active linkage 610. In embodiments, the temperature control actuators 611 are heaters, such as resistive heaters, and are used to heat the active linkage 610. In such embodiments, passive cooling may be used to reduce the temperature of the active linkage 610 when the temperature control actuators 611 are deactivated. In embodiments, the temperature control actuators 611 are coolers, such as Peltier coolers, and are used to cool the active linkage 610. In such embodiments, passive warming may be used to increase the temperature of the active linkage 610 when the temperature control actuators 611 are deactivated. In further embodiments, temperature control actuators 611 may include both heaters and coolers and may actively adjust the temperature of the active linkage 610 up and down to modify the stiffness and buckling strength of the active linkage 610. Accordingly, the buckling strength of the active linkage 610 may be modified according to an actuator control signal configured to cause a temperature adjustment of the active linkage 610. The active linkage 610 may be employed with the kinesthetic actuation system 100 as described in detail with respect to FIGS. 1 and 2. Although the active linkage 610 includes a circular cross-section, shape memory based active linkages may have cross-sections of any suitable shape, including rectangular, ovoid, elliptical, etc.

FIGS. 8A and 8B illustrate an active linkage 710 consistent with embodiments hereof. The active linkage 710 includes a liquid metal tube 712 surrounding a core element 713. The core element 713 is a wire having a circular cross-section configured to provide strength in tension, as shown in FIG. 8A. In further embodiments, the active linkage 710 may include a core element 717 that is formed by a rectangular cross-section ribbon structure as shown in FIG. 8B, and described above, or any other suitable structure. The liquid metal tube 712 surrounds the core element 713 and may be activated to increase the buckling strength of the active linkage 710. The liquid metal tube 712 includes a shell 714 containing a liquid metal 715. The active linkage 710 may be activated through temperature changes to adjust its buckling strength. Increasing the temperature of the liquid metal 715 beyond a melting point causes the metal to liquefy, which reduces the buckling strength of the active linkage 710. Similarly, reducing the temperature of the liquid metal 715 below the melting point causes the liquid metal to solidify to cause an increase in stiffness and a corresponding increase in buckling strength of the active linkage 710. The liquid metal 715 may be selected to have a melting point at or near room temperature, e.g., between 25-30° C. Liquid metals having a melting point at or near room temperature include, for example, elemental metals Gallium, Francium, and Cesium as well as alloys, such as alloys of Gallium, Indium, and Tin. The temperature of the active linkage 710 may be adjusted via temperature control actuators 711 disposed on the active linkage 710, disposed on the hinges of a kinesthetic actuation system, and/or disposed in any other location from which they may heat or cool the active linkage 710. In embodiments, the temperature control actuators 711 are heaters, such as resistive heaters, and are used to heat the active linkage 710. In such embodiments, passive cooling may be used to reduce the temperature of the active linkage 710 when the temperature control actuators 711 are deactivated. In embodiments, the temperature control actuators 711 are coolers, such as Peltier coolers, and are used to cool the active linkage 710. In such embodiments, passive warming may be used to increase the temperature of the active linkage 710 when the temperature control actuators 711 are deactivated. In further embodiments, temperature control actuators 711 may include both heaters and coolers and may actively adjust the temperature of the active linkage 710 up and down to modify the stiffness and buckling strength of the active linkage 710. Accordingly, the buckling strength of the active linkage 710 may be modified according to an actuator control signal configured to cause a temperature adjustment of the active linkage 710. The active linkage 710 may be employed with the kinesthetic actuation system 100 as described in detail with respect to FIGS. 1 and 2.

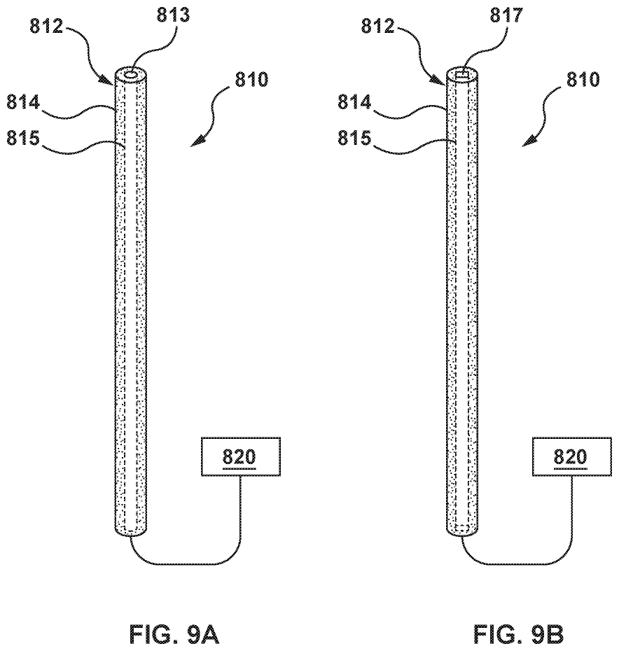

FIGS. 9A and 9B illustrate an active linkage 810 consistent with embodiments hereof. The active linkage 810 includes an air jamming structure 812 surrounding a core element 813. The core element 813 is a wire having a circular cross-section, as shown in FIG. 9A, configured to provide strength in tension. In further embodiments, the active linkage 810 may include a core element 817 formed from a rectangular cross-section ribbon structure as shown in FIG. 9B, and as described above, or any other suitable structure. The air jamming structure 812 surrounds the core element 813 and may be activated to increase the buckling strength of the active linkage 810. The air jamming structure 812 includes a bladder 814 containing air jamming particles 815. The active linkage 810 is activated by a vacuum source 820 to adjust its buckling strength. The bladder 814 is filled with a plurality air jamming particles 815. The air jamming particles 815 may include granular particles, interleaved layers, and/or other pieces. When inactive, the air jamming particles 815 are free to shift and move relative to one another, and the active linkage 810 remains flexible. The vacuum source 820 is operated in response to an actuator control signal to evacuate all or a portion of the air contained in the bladder 814. The air evacuation causes the bladder 814 to compress the air jamming particles 815 contained within. When forced together, with no air between, the air jamming particles 815 can no longer move or shift relative to one another. The immobilization of the air jamming particles 815 causes an increase in the stiffness of air jamming structure 812 and thus an increase in the buckling strength of the active linkage 810. The active linkage 810 may be employed with the kinesthetic actuation system 100 as described in detail with respect to FIGS. 1 and 2.

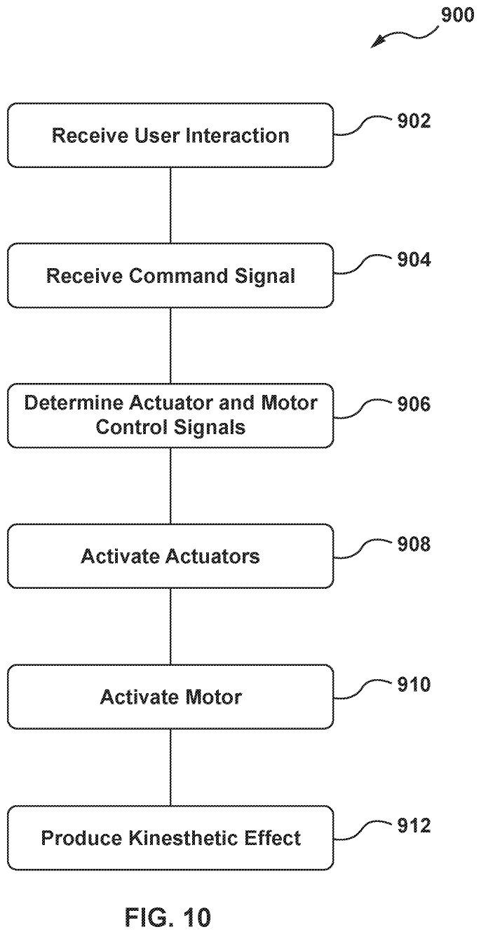

FIG. 10 is a flow diagram illustrating a kinesthetic actuation process 900 of applying kinesthetic effects via a kinesthetic actuation system as described herein. A kinesthetic actuation system for use with the kinesthetic actuation process may include at least an active linkage, a motor, and one or more hinges and may be configured according to any combination of the embodiments disclosed above. The process 900 may be performed via any of the kinesthetic actuation systems described herein using any combination of features, as may be required for the various operations of the process. The kinesthetic actuation process 900 may be carried out with more or fewer of the described operations, in any order.

In an operation 902, the kinesthetic actuation process 900 includes receiving, by a central processing unit or other computing device, a user interaction. The central processing unit or other computing device runs a software application with which a user interacts. The software application may include an immersive reality function, for example. In an immersive reality software application, the user interaction may include, for example, a user virtually interacting with an object within the immersive reality. Based on the virtual user interaction, the central processing unit determines to provide a kinesthetic effect to a user. For example, where a user attempts to grasp a virtual object, the central processing unit determines to provide a kinesthetic effect serving to prevent a user's hand or finger from closing, to simulate the resistance provided by the virtual object. This example is illustrative only, and any suitable interaction may give rise to a kinesthetic effect. Furthermore, embodiments discussed herein are not limited to immersive reality functions, and may include user interactions with administrative software, design software, programming software, and any other suitable software application.

The central processing unit provides a command signal including the necessary information for carrying out the kinesthetic effect to the kinesthetic actuation system. As discussed above, kinesthetic effects may include effects that provide force to move a user's finger (e.g., bending or unbending), a force to resist a user's movement of a finger, and/or a vibration effect.

In an operation 904, the kinesthetic actuation process 900 includes receiving, by a control unit associated with the kinesthetic actuation system, the command signal for carrying out the kinesthetic effect selected by the central processing unit. In embodiments, the received command signal may be a high level command signal that includes instructions to carry out a specific kinesthetic effect, e.g., provide resistance to a specific user finger. In further embodiments, the received command signal may include specific control signals, e.g., signals specifying that a specific actuator or motor should be activated in a specific way. In still other embodiments, the command signal may include signals configured to activate the motors and actuators of the kinesthetic actuation system.

In an operation 906, the kinesthetic actuation process 900 includes determining, by a processor associated with the control unit, the actuator control signal and the motor control signal. When receiving a high level control signal, the processor may determine the appropriate actuator and motor control signals based on the high level control signal. For example, a high level command signal containing instructions to provide a pushing force kinesthetic effect on a user finger may require the processor to determine an actuator control signal for activating the actuators necessary for an appropriate buckling strength increase in the active linkage and a motor control signal for activating the motor to advance the active linkage. In another example, the command signal may require less analysis by the processor and may include the appropriate actuator control signal and motor control signal to be routed directly to the actuators and motor of the kinesthetic actuation system.

In an operation 908, the kinesthetic actuation process 900 includes activating one or more actuators to modify the buckling strength of the active linkage. The processor of the control unit provides an actuator control signal to the one or more actuators to modify the buckling strength of the active linkage. The actuators activated by the actuator control signal may include any of the actuators discussed herein, including actuators disposed on the active linkage, actuators disposed on or near the motor, and actuators disposed on the hinges of the kinesthetic actuation system. As discussed above, activation of the actuators causes a modification of the buckling strength of the active linkage as either an increase in the buckling strength or decrease in the buckling strength of the active linkage. In some embodiments, operation 908 may further include, or alternatively include, deactivation of the one or more actuators to modify the buckling strength of the active linkage.

In an operation 910, the kinesthetic actuation process 900 includes activating the motor of the kinesthetic actuation system to advance or retract the active linkage. The motor receives a motor control signal and, in response, operates to extend or retract the active linkage.

In an operation 912, the kinesthetic actuation process 900 includes applying a kinesthetic effect to the user. The combination of the extension or retraction of the active linkage and the modification to the buckling strength of the active linkage provides a kinesthetic effect to the user. Kinesthetic effects to cause bending of a finger may include pushing of the active linkage, which requires increased buckling strength and advancement of the active linkage. In such effects, the active linkage is used to apply pushing forces to the hinges to cause a user's finger to bend. Kinesthetic effects to cause unbending of a finger may include pulling of the active linkage, which requires retraction of the active linkage and no actuator activation. In such effects, the active linkage is used to apply pulling forces to cause a user's finger to unbend. In some embodiments, the buckling strength of the active linkage is reduced prior to retraction, through transmission of a specific actuation signal. In some embodiments, the increased buckling strength of the active linkage is maintained during a retraction operation. In still further embodiments, the buckling strength of the active linkage is permitted to naturally decrease in the absence of any actuator control signals to maintain it.

Kinesthetic effects may further include resistance effects, whereby the active linkage is used to generate resistance to movement of the user's finger. For example, the active linkage may have its buckling strength increase be used to generate a torque to counteract an unbending motion of a user's finger. In another example, the active linkage may have its buckling strength decreased and be used to generate a torque to counteract a bending motion of a user's finger. Resistance to a bending motion may also take place when the active linkage remains in an activated high buckling strength state. Finally, kinesthetic effects may further include vibration effects, provided via an oscillating signal applied to the active linkage.

The above describes an illustrative flow of an example process 900 of providing a kinesthetic effect. The process as illustrated in FIG. 10 is exemplary only, and variations exist without departing from the scope of the embodiments disclosed herein. The steps may be performed in a different order than that described, additional steps may be performed, and/or fewer steps may be performed.

### ADDITIONAL DISCUSSION OF VARIOUS EMBODIMENTS

Embodiment 1 is a system for applying kinesthetic effects, the system comprising: a control unit including at least one processor and configured to output an actuator control signal and a motor control signal; an active linkage configured to have an adjustable buckling strength, the buckling strength being adjustable in response to the actuator control signal; a motor configured to advance and retract the active linkage in response to the motor control signal; and a hinge configured to convert a translation force supplied by the active linkage into torque to apply a kinesthetic effect.

Embodiment 2 is the system of embodiment 1, wherein the hinge includes a rotation element and a frame, the frame being configured to receive the translation force supplied by the active linkage whereby the translation force causes the frame to rotate around the rotation element.

Embodiment 3 is the system of embodiment 1 or 2, wherein the rotation element of the hinge is configured to be secured to a finger of a user, and the frame is configured to apply torque to the finger of the user when rotated around the rotation element by the translation force supplied by the active linkage.

Embodiment 4 is the system of any of embodiments 1-3, wherein the control unit is further configured to output the actuator control signal for increasing the buckling strength of the active linkage, when the active linkage is advanced, and to not output an actuator control signal, when the active linkage is retracted.

Embodiment 5 is the system of any of embodiments 1-3, wherein the control unit is further configured to output a first actuator control signal for increasing the buckling strength of the active linkage when the active linkage is advanced, and to output a second actuator control signal for decreasing the buckling strength of the active linkage, when the active linkage is retracted.

Embodiment 6 is the system of any of embodiments 1-5, wherein the active linkage includes a ribbon structure having at least one actuator mounted thereon, and the at least one actuator is configured to induce a curvature in the ribbon structure to increase the buckling strength of the ribbon structure, when the actuator control signal is received by the at least one actuator.

Embodiment 7 is the system of any of embodiments 1-5, wherein the active linkage includes a shape memory material and the actuator control signal is configured to change a temperature of the active linkage to adjust the buckling strength.

Embodiment 8 is the system of any of embodiments 1-5, wherein the active linkage includes a liquid metal tube surrounding a core element and the actuator control signal is configured to change a temperature of the liquid metal tube to adjust the buckling strength.

Embodiment 9 is the system of any of embodiments 1-5, wherein the active linkage includes a ribbon structure, and the hinge includes an actuator configured to apply a force to the ribbon structure that induces a curvature in the ribbon structure to increase the buckling strength of the ribbon structure, when the actuator control signal is received by the actuator.

Embodiment 10 is the system of any of embodiments 1-5, further comprising a spool configured to be rotated by the motor, wherein the active linkage is advanced and retracted via rotation of the spool.

Embodiment 11 is a method for applying kinesthetic effects, the method comprising: adjusting, via an actuator control signal output by a processor, a buckling strength of an active linkage; causing, via a motor signal output by the processor, a motor to translate the active linkage between advanced and retracted positions; providing a translation force to the hinge via the active linkage; and converting the translation force supplied into torque at the hinge to apply a kinesthetic effect.

Embodiment 12 is the method of embodiment 11, wherein converting the translation force includes: applying the translation force to a frame of the hinge via the active linkage; and rotating the frame around a rotation element of the hinge.

Embodiment 13 is the method of embodiment 11 or 12, wherein the hinge is secured to a finger of a user and converting the translation force further comprises applying the torque to the finger by contact between the frame and the finger when the frame is rotated around the rotation element.

Embodiment 14 is the method of any of embodiments 11-13, wherein adjusting the buckling strength of the active linkage includes increasing the buckling strength by the actuator control signal, when the active linkage is advanced, and outputting no actuator control signal, when the active linkage is retracted.

Embodiment 15 is the method of any of embodiments 11-13, wherein adjusting the buckling strength of the active linkage includes increasing the buckling strength by the actuator control signal, when the active linkage is translated to the advanced position, and decreasing the buckling strength by the actuator control signal, when the active linkage is translated to the retracted position.

Embodiment 16 is the method of any of embodiments 11-15, wherein the active linkage includes a ribbon structure having at least one actuator mounted thereon, and wherein adjusting the buckling strength includes inducing a curvature in the ribbon structure, to increase the buckling strength, by activating the at least one actuator with the actuator control signal.

Embodiment 17 is the method of any of embodiments 11-15, wherein the active linkage includes a shape memory material, and wherein adjusting the buckling strength of the active linkage further comprises changing the temperature of the active linkage.

Embodiment 18 is the method of any of embodiments 11-15, wherein the active linkage includes a liquid metal tube surrounding a core element, and wherein adjusting the buckling strength of the active linkage further comprises changing the temperature of the liquid metal tube.

Embodiment 19 is the method of any of embodiments 11-15, wherein the active linkage includes a ribbon structure and the hinge includes an actuator, and wherein adjusting the buckling strength of the active linkage further comprises receiving the actuator control signal by the actuator and applying a curvature inducing force to the ribbon structure by the actuator to increase the buckling strength of the ribbon structure.

Thus, there are provided systems, devices, and methods for providing multi-direction kinesthetic actuation systems. While various embodiments according to the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments but should be defined only in accordance with the appended claims and their equivalents. It will also be understood that each feature of each embodiment discussed herein, and of each reference cited herein, can be used in combination with the features of any other embodiment. Aspects of the above methods of generating kinesthetic effects may be used in any combination with other methods described herein or the methods can be used separately. All patents and publications discussed herein are incorporated by reference herein in their entirety.

What is claimed is:

1. A system for applying kinesthetic effects, the system comprising:
a control unit including at least one processor and configured to output an actuator control signal and a motor control signal;
an active linkage configured to have an adjustable buckling strength, the buckling strength being adjustable in response to the actuator control signal;
a motor configured to advance and retract the active linkage in response to the motor control signal; and
a hinge configured to convert a translation force supplied by the active linkage into torque to apply a kinesthetic effect.

2. The system of claim 1, wherein the hinge includes a rotation element and a frame, the frame being configured to receive the translation force supplied by the active linkage whereby the translation force causes the frame to rotate around the rotation element.

3. The system of claim 2, wherein the hinge is configured to be secured to a finger of a user, and the frame is configured to apply torque to the finger of the user when rotated around the rotation element by the translation force supplied by the active linkage.

4. The system of claim 1, wherein the control unit is further configured
to output the actuator control signal for increasing the buckling strength of the active linkage, when the active linkage is advanced, and
to not output an actuator control signal, when the active linkage is retracted.

5. The system of claim 1, wherein the control unit is further configured
to output a first actuator control signal for increasing the buckling strength of the active linkage when the active linkage is advanced, and
to output a second actuator control signal for decreasing the buckling strength of the active linkage, when the active linkage is retracted.

6. The system of claim 1, wherein the active linkage includes a ribbon structure having at least one actuator mounted thereon, and the at least one actuator is configured to induce a curvature in the ribbon structure to increase the buckling strength of the ribbon structure, when the actuator control signal is received by the at least one actuator.

7. The system of claim 1, wherein the active linkage includes a shape memory material and the actuator control signal is configured to change a temperature of the active linkage to adjust the buckling strength.

8. The system of claim 1, wherein the active linkage includes a liquid metal tube surrounding a core element and the actuator control signal is configured to change a temperature of the liquid metal tube to adjust the buckling strength.

9. The system of claim 1, wherein the active linkage includes a ribbon structure, and the hinge includes an actuator configured to apply a force to the ribbon structure that induces a curvature in the ribbon structure to increase the buckling strength of the ribbon structure, when the actuator control signal is received by the actuator.

10. The system of claim 1, further comprising a spool configured to be rotated by the motor, wherein the active linkage is advanced and retracted via rotation of the spool.

11. A method for applying kinesthetic effects, the method comprising:
adjusting, via an actuator control signal output by a processor, a buckling strength of an active linkage;
causing, via a motor signal output by the processor, a motor to translate the active linkage between advanced and retracted positions;
providing a translation force to the hinge via the active linkage; and
converting the translation force supplied into torque at the hinge to apply a kinesthetic effect.

12. The method of claim 11, wherein converting the translation force includes:
applying the translation force to a frame of the hinge via the active linkage; and
rotating the frame around a rotation element of the hinge.

13. The method of claim 12, wherein the hinge is secured to a finger of a user and converting the translation force further comprises applying the torque to the finger by contact between the frame and the finger when the frame is rotated around the rotation element.

14. The method of claim 11, wherein adjusting the buckling strength of the active linkage includes
increasing the buckling strength by the actuator control signal, when the active linkage is advanced, and
outputting no actuator control signal, when the active linkage is retracted.

15. The method of claim 11, wherein adjusting the buckling strength of the active linkage includes
increasing the buckling strength by the actuator control signal, when the active linkage is translated to the advanced position, and
decreasing the buckling strength by the actuator control signal, when the active linkage is translated to the retracted position.

16. The method of claim 11, wherein the active linkage includes a ribbon structure having at least one actuator mounted thereon, and wherein adjusting the buckling strength includes inducing a curvature in the ribbon structure, to increase the buckling strength, by activating the at least one actuator with the actuator control signal.

17. The method of claim 11, wherein the active linkage includes a shape memory material, and wherein adjusting the buckling strength of the active linkage further comprises changing the temperature of the active linkage.

18. The method of claim 11, wherein the active linkage includes a liquid metal tube surrounding a core element, and wherein adjusting the buckling strength of the active linkage further comprises changing the temperature of the liquid metal tube.

19. The method of claim 11, wherein the active linkage includes a ribbon structure and the hinge includes an actuator, and wherein adjusting the buckling strength of the active linkage further comprises receiving the actuator control signal by the actuator and applying a curvature inducing force to the ribbon structure by the actuator to increase the buckling strength of the ribbon structure.
